(19) United States
(12) Patent Application Publication
(10) Pub. No.: US 2012/0039468 A1
(43) Pub. Date: Feb. 16, 2012

(54) WIRELESS COMMUNICATION APPARATUS

(75) Inventors: Chie Ishida, Kanagawa (JP); Takahisa Aoyama, Kanagawa (JP); Takashi Tamura, Kanagawa (JP)

(73) Assignee: PANASONIC CORPORATION, Osaka (JP)

(21) Appl. No.: 13/264,264

(22) PCT Filed: Apr. 9, 2010
(86) PCT No.: PCT/JP2010/002626

§ 371 Date: Oct. 13, 2011

(30) Foreign Application Priority Data
Apr. 17, 2009 (JP) 2009-101294

(51) Int. Cl. H04K 1/02

(52) U.S. Cl. 380/247

(57) ABSTRACT

To make it possible for a legacy user equipment to correctly generate and use a common key between a user equipment and a base station and between the user equipment and a relay node when the relay nodes are being introduced. An HO request processing unit (202) extracts user equipment information from an HO request input from a receiver (201). A user equipment information determination section (204) determines a mode of handover from the user equipment information, and outputs a determination result to a key generator (205), a key information update request preparation section (206), and an HO command generator (207). In a case of handover from one base station to a relay node of another base station or to the other base station, the user equipment information determination section (204) commands the key information update request preparation section (206) to prepare a key information update request to a high-level management node so as to update the key information.

### TECHNICAL FIELD

The present invention relates to a field of wireless communication technology and, more particularly, to a wireless communication apparatus applicable to a wireless communication base station apparatus, a wireless communication user equipment, or the like.

### BACKGROUND ART

The 3rd-generation Partnership Project (3GPP) that is an international standardization organization for mobile communication has pursued standardization of LTE (Long Term Evolution) as a next-generation mobile communication system. An LTE-Advanced (Long Term Evolution Advanced) system is a communication system evolved from LTE and aims at providing further enhanced mobile communication service.

In relation to a cellular mobile communication system, techniques for accomplishing a high transmission rate by utilization of a high-frequency wireless band have recently been studied actively in order to realize large-volume data transfer in accordance with a trend toward multimedia information.

However, when a high-frequency wireless band is utilized, accomplishment of a high transmission rate can be expected within a short distance, whilst attenuation attributable to an increase in transmission distance becomes greater as the distance becomes longer. Therefore, when the mobile communication system utilizing the high-frequency wireless band is actually put into practice, a communication area covered by a base station becomes smaller, which in turn raises a necessity to install a larger number of base stations. Since installing base stations involves consumption of commensurate cost, techniques for realizing communication service utilizing a high-frequency wireless band while suppressing an increase in the number of base stations have been strongly desired.

As shown in FIG. 1, in answer to such a demand, introducing into a mobile communication network system a relay node (RN) assuming a role of relaying communication between a base station and a user equipment has been conceived in order to enlarge a communication area covered by each of base stations. FIG. 1 is an illustration showing an example configuration of a cellular mobile communication system including introduced relay nodes. Relay nodes 103A, 103B, and 103C are installed along a cell edge corresponding to a periphery of a communication area 111 covered by a base station 101 with a view toward enhancing receiving efficiency of the base station 101 achieved at the cell edge. The relay nodes 103A, 103B, and 103C belong to at least one base station 101 of neighbor base stations and have a function of relaying communication between the corresponding base station 101 and a user equipment 102.

Since communication between the user equipment and the base station is performed along a wireless path, encryption keys are used in order to carry out secure communication. By reference to FIGS. 8 and 9, generation of keys during establishment of a connection between the user equipment and the base station and exchange of keys during handover are now described. FIG. 8 is a sequence diagram showing procedures for generating keys at the time of establishment of a connection between a user equipment and a base station. FIG. 9 is a sequence diagram showing procedures for exchanging keys during handover.

As shown in FIG. 8, a user equipment (UE: User Agent) 1502 and an MME (Mobility Management Entity) 1505 that is a high-level management node hold a common key K_ASME. Each of the user equipment and the MME multiplies the K_ASME by a NAS (Non Access Stratum) uplink count (NAS UL COUNT), thereby generating a key K_eNB (S501 and S503). Key information NH (Next Hop) is produced from the key K_ASME and the key K_eNB (S502 and S504). Generation of keys is performed at authentication of a user equipment in the cellular mobile communication system and updating of the key K_ASME, such as power-on of the user equipment 1502.

When establishing an RRC (Radio Resource Control) connection with a base station (eNB: evolved Node-B) 1501, the user equipment 1502 transmits and receives an RRC connection request (RRC connection req), an RRC connection setup, and an RRC connection setup complete between the user equipment 1502 and the base station 1501 (S505, S506, and S507), and an NAS message is transferred from the base station 1501 to the MME 1505 (S508). The MME 1505 notifies the base station 1501 of the key K_eNB and the key information NH (S509). The NCC (NH Chaining Counter) performs count-up operation every time the key information NH is updated and shows the number of time key information NH is produced and the number of times the key information NH is updated.

During communication performed after establishment of the RRC connection, the user equipment 1502 and the base station 1501 can perform secure communication by use of a common key K_eNB. When performing secure communication, an SMC (Security Mode Command), an RRC connection reconfiguration, SMC complete, and RRC connection reconfiguration complete are exchanged between the base station 1501 and the user equipment 1502 (S510, S511, S512, and S513). In a subsequent session, communication is performed by means of data encrypted by use of the encryption keys. At this time, the user equipment 1502, the base station 1501, and the MME 1505 hold a common key K_eNB and the key information NH (NCC=1).

As shown in FIG. 9, the user equipment is assumed to perform handover from one base station that is now in communication with the user equipment to another different base station. The user equipment (UE) 1502 holds a connection with a base station (i.e., with a source base station: SeNB) 1501A in a currently communicable serving cell and is using the key K_eNB for communication encryption.

The user equipment 1502 sends a measurement report (MR) including receiving quality of a pilot signal from a base station (i.e., from a target base station: TeNB) 1501B that is to act as a handover destination for the source base station 1501A of the serving cell (S521). The user equipment 1502 measures receiving quality of the target base station 1501B and acquires a physical cell ID (PCI).

After determined a received measurement report and also determined the handover destination as a target base station, the source base station 1501A transmits an HO (Handover) request (HO req) indicating a handover request to the target base station 1501B. At this time, the source base station 1501A produces a key K_eNB* from the key K_eNB used in communication with the user equipment 1502 and the physical cell ID of the target base station 1501B (S522). The key K_eNB* is transmitted to the target base station 1501B while included in the HO request in conjunction with the key information NH (S523).

Upon receipt of the HO request from the source base station 1501A, the target base station 1501B acquires the key K_eNB* and the key information NH included in the HO request and transmits the HO command representing handover to the user equipment 1502 by way of the source base station 1501A (S524 and S525).

Upon receipt of the HO command transmitted from the target base station 1501B by way of the source base station 1501A, the user equipment 1502 produces a new key K_eNB* from the key K_eNB used in communication with the source base station 1051A and the previously acquired physical cell ID of the target base station 1501B (S526).

Subsequently, the user equipment 1502 transmits to the target base station 1501B an RACH (Random Access Channel) message (Synchronization) for assuring synchronization (S527), and an uplink resource (UL allocation) is given by the target base station 1501B (S528). The RRC connection reconfiguration complete (RRC connection reconfig comp) is transmitted from the user equipment 1502 to the target base station 1501B (S529), and a path switching request (Path Switching request) is transmitted from the target base station 1501B to the MME 1505 (S530). The MME 1505 updates the key information to new key information NH* (NCC=2) from the key K_ASME and the key information NH (S531). The key information NH* is transmitted to the target base station 1501B while included in an ACK response (ack) (S532). Handover is performed from one base station to another base station through a round of above-mentioned processing operations.

In a session subsequent to handover, the new key K_eNB* is used for encrypting communication between the user equipment 1502 and the target base station 1501B, and the old key K_eNB is deleted.

### CITATION LIST

### Patent Literature

Patent Literature 1: WO2006/003859A1

### Non-Patent Literature

Non-Patent Literature 1: 3GPP TS 33.401 v8.2.1 “3GPP System Architecture Evolution (SAE): Security Architecture: (Release 8)”

### SUMMARY OF THE INVENTION

### Technical Problem

A cellular mobile communication system is assumed to perform secure communication that uses encryption keys, such as those mentioned above, by means of introducing relay nodes in order to enlarge communication areas covered by respective base stations. When the relay nodes are being introduced, a legacy user equipment that is not expected to utilize a relay node can only perform traditional operation for generating a key. Therefore, the legacy user equipment raises a problem of being incapable of correctly generating and using a common key between the user equipment and the relay node and between the user equipment and the base station.

The present invention has been conceived in the circumstances and aims at making it possible for a legacy user equipment to correctly generate and use a common key between a user equipment and a base station and between the user equipment and a relay node when the relay nodes are being introduced into a cellular mobile communication system.

### Solution to Problem

The present invention provides, as a first aspect, a wireless communication apparatus, including: a receiver that receives a handover request representing a request for handover, which is sent from another apparatus, and receives key information about an encryption key; a handover request processing unit that processes the handover request received by the receiver; a key information storage section that stores the key information received by the receiver; a user equipment information determination section that determines a mode of handover in accordance with user equipment information extracted by the handover request processing unit; a key generator that generates a key from the key information stored in the key information storage section in accordance with a determination result of the user equipment information determination section; a key information update request preparation section that prepares a key information update request for requesting updating of key information in accordance with a determination result of the user equipment information determination section; a handover command preparation section that prepares a handover command for commanding execution of handover in accordance with a determination result of the user equipment information determination section; and a transmitter that transmits the key information update request prepared by the key information update request preparation section and the handover command prepared by the handover command preparation section.

By means of the configuration, it becomes possible to perform preparation of a key information update request and a handover command, generation of a key, updating of the key, and other operations, on the basis of a mode of handover and in accordance with a determination result based on user equipment information. It thereby becomes possible for a legacy user equipment to correctly generate and use a common key between a user equipment and a base station and between the user equipment and a relay node when the relay nodes are being introduced into a cellular mobile communication system.

The present invention includes, as a second aspect, the wireless communication apparatus, wherein either when a user equipment that is in communication with the apparatus which has transmitted the handover request performs handover from a relay node to a high-level base station to which the relay node is subordinate or when the user equipment performs handover from a base station or a relay node subordinate to the base station to another base station or a relay node subordinate to the other base station, the user equipment information determination section commands the key information update request preparation section to prepare a key information update request to a high-level management node.

By means of the configuration, when there is performed handover from a relay node to a high-level base station to which the relay node is subordinate or handover from one base station or a relay node subordinate to the base station to another base station or a relay node subordinate to the other base station, the key information update request to the high-level management node is prepared and notified, whereby key information for generating a key can be updated. When relay nodes are being introduced into a wireless communication system involving a legacy user equipment, a common key between the user equipment and the base station and between the user equipment and the relay node can be correctly generated and used.

The present invention includes, as a third aspect, the wireless communication apparatus, wherein, when the user equipment is a legacy user equipment which is not expected to utilize a relay node, the user equipment information determination section commands the key information update request preparation section to prepare the key information update request.

By means of the configuration, in the case of handover to the legacy user equipment, a key information update request for the high-level management node is prepared and notified, whereby key information for generating a key can be appropriately updated by the legacy user equipment. Therefore, when relay nodes are being introduced into a wireless communication system involving presence of a legacy terminal, a common key between the user equipment and the base station and between the user equipment and the relay node can be correctly generated and used.

A fourth aspect of the present invention provides a base station apparatus including any one of the pieces of previously-described wireless communication apparatus.

A fifth aspect of the present invention provides a wireless communication system including the previously-described base station apparatus.

### Advantageous Effect of the Invention

The present invention makes it possible for a legacy user equipment to correctly generate and use a common key between a user equipment and a base station and between the user equipment and a relay node when the relay nodes are being introduced into a cellular mobile communication system.

### BRIEF DESCRIPTION OF THE DRAWINGS

FIG. 1 is an illustration showing an example configuration of a cellular mobile communication system into which relay nodes are being introduced.

FIG. 2 is a block diagram showing a configuration of a base station according to a first embodiment of the present invention.

FIG. 3 is a block diagram showing a configuration of a user equipment according to the first embodiment of the present invention.

FIG. 4 is a flowchart showing operation of the base station according to the first embodiment of the present invention.

FIG. 5 is a flowchart showing operation of the user equipment according to the first embodiment of the present invention.

FIG. 6 is a signaling diagram showing first example signaling between the base station and the user equipment according to the first embodiment of the present invention.

FIG. 7 is a signaling diagram showing second example signaling between the base station and the user equipment according to the first embodiment of the present invention.

FIG. 8 is a sequence diagram showing procedures for generating a key at the time of establishment of a connection between the user equipment and the base station.

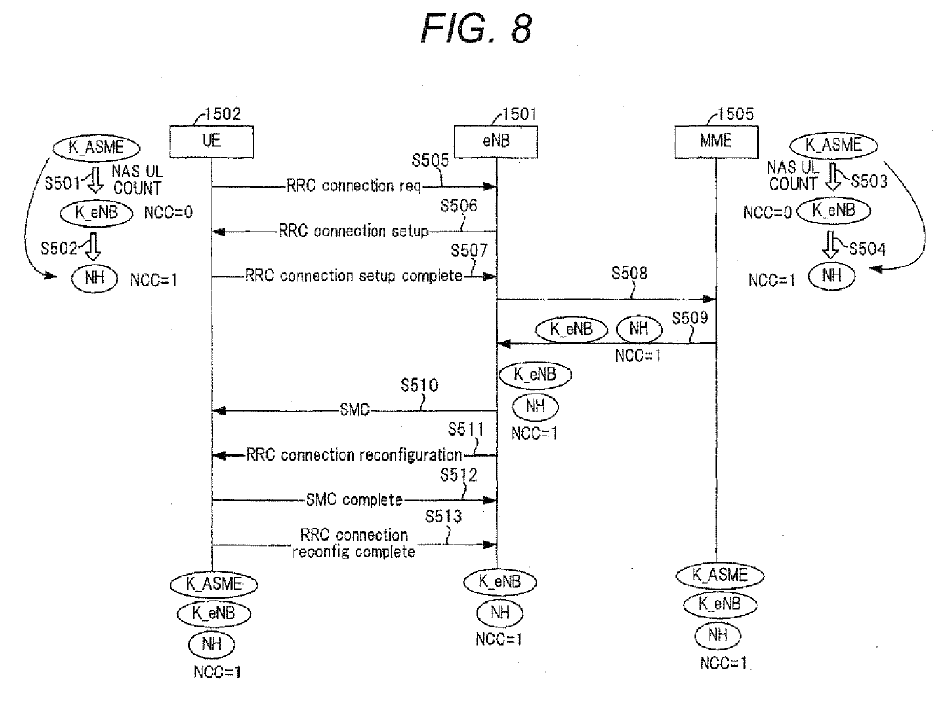

FIG. 9 is a sequence diagram showing procedures for exchanging a key during handover.

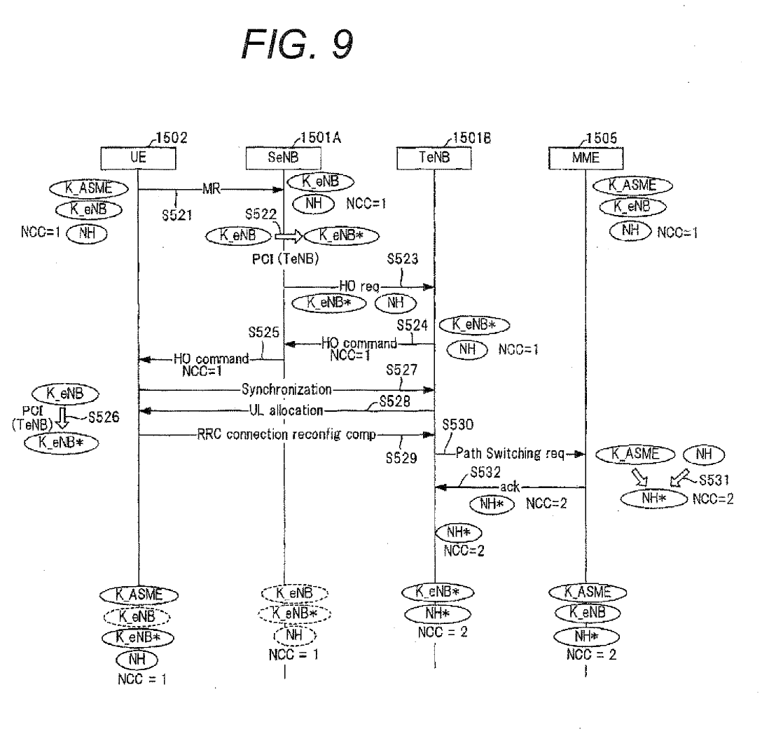

### DESCRIPTION OF THE EMBODIMENT

An embodiment of the present invention will be hereunder described in detail by reference to the drawings. In the embodiments, configurations having the same functions are assigned the same reference signs/numerals, and their repeated explanations are omitted.

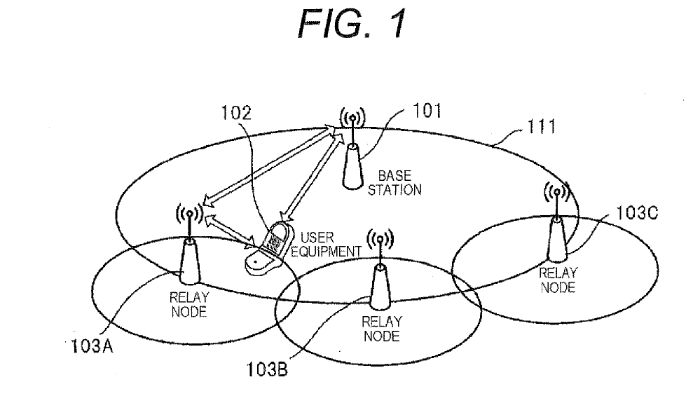

The embodiment shows an example in which a wireless communication apparatus according to an aspect of the present invention is applied to a cellular mobile communication system for mobile communication, such as a portable phone. As shown in FIG. 1, the cellular mobile communication system of the embodiment is configured such that relay nodes 103A, 103B, and 103C are installed along a cell edge of a base station 101, to thus enable the relay nodes 103A, 103B, and 103C to relay communication between the base station 101 and the user equipment 102. LTE, LTE-Advanced, or the like, is applicable to the communication system.

### First Embodiment

A first embodiment provides a proposal for determining a command for updating an encryption key sent to a user equipment or a high-level management node according to release information about the user equipment and a mode of handover when the base station has received an HO request representing a handover request from another device. Even when the relay nodes are being introduced and when a legacy user equipment is included in user equipments, it is possible to correctly generate and use a common key between the user equipment and the base station and between the user equipment and the relay node.

In the first embodiment, unless otherwise specified, the user equipment is assumed to designate a legacy user equipment that is not expected to utilize a relay node and that is solely compatible with a communication system into which relay nodes have not yet been introduced.

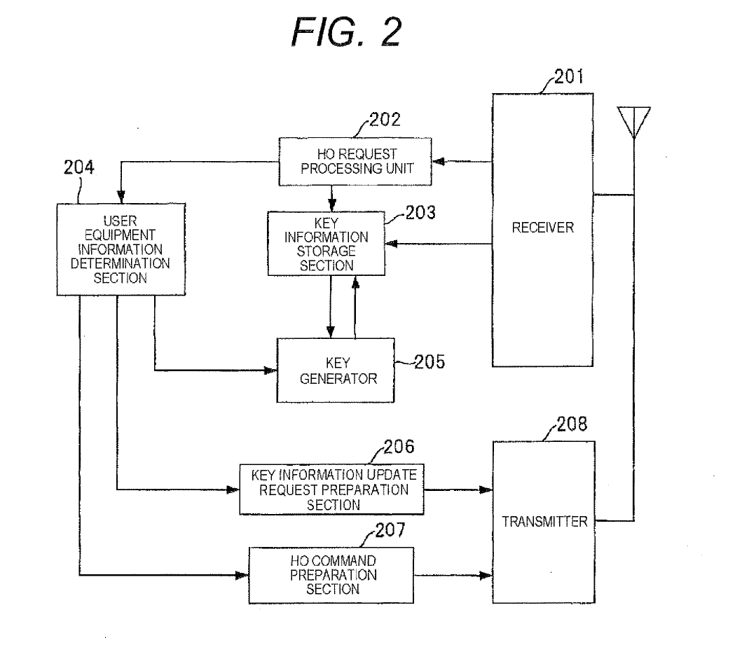

The configuration of the base station according to the first embodiment of the present invention is described by reference to a block diagram shown in FIG. 2.

A receiver 201 has a reception RF section, a baseband signal processing unit, and the like, and performs processing for demodulation, decoding, and the like, of a signal received by an antenna. The receiver 201 receives an HO request, which is a handover request from another base station, and information about an encryption key from a high-level management node, or the like. The receiver 201 outputs the thus-received HO request to an HO request processing unit 202 and the thus-received information to a key information storage section 203.

The HO request processing unit 202 extracts user equipment information from the HO request input from the receiver 201 and outputs the thus-extracted user equipment information to a user equipment information determination section 204. The HO request processing unit 202 extracts key information included in the HO request and outputs the thus-extracted key information to the key information storage section 203.

The user equipment information determination section 204 determines a mode of handover from the user equipment information input by the HO request processing unit 202 and outputs a determination result to a key generator 205, a key information update request preparation section 206, and an HO command generator 207. Determination about a mode of handover on the basis of user equipment information includes handover from a relay node to a base station, handover from a base station to a relay node, handover from one base station to another base station, and the like. In the case of handover relating to relay nodes, a determination of handover includes handover between relay nodes subordinate to the same base station, handover to a different base station to which the relay node is not subordinate, handover to a relay node subordinate to the different base station, and the like.

The key generator 205 acquires required key information from the key information storage section 203 according to a determination result input by the user equipment information determination section 204, generates an encoding key, and outputs the thus-generated key to the key information storage section 203.

The key information storage section 203 stores key information input by the receiver 201, the HO request processing unit 202, and the key generator 205. Further, required key information is output to the key generator 205.

The key information update request preparation section 206 prepares a key information update request for requesting updating of key information according to a determination result input by the user equipment information determination section 204 and outputs the thus-prepared request to a transmitter 208.

The HO command generator 207 prepares an HO command that is a response command for commanding execution of handover in response to the HO request from another base station according to the determination result input by the user equipment information determination section 204; and outputs the thus-generated HO command to a transmitter 208.

The transmitter 208 has a baseband signal processing unit, a transmission RF block, and the like, and performs encoding, modulation, and like processing, of a transmission signal. The transmitter 208 transmits by way of an antenna the key information update request input by the key information update request preparation section 206 and the HO command input by the HO command preparation section 207.

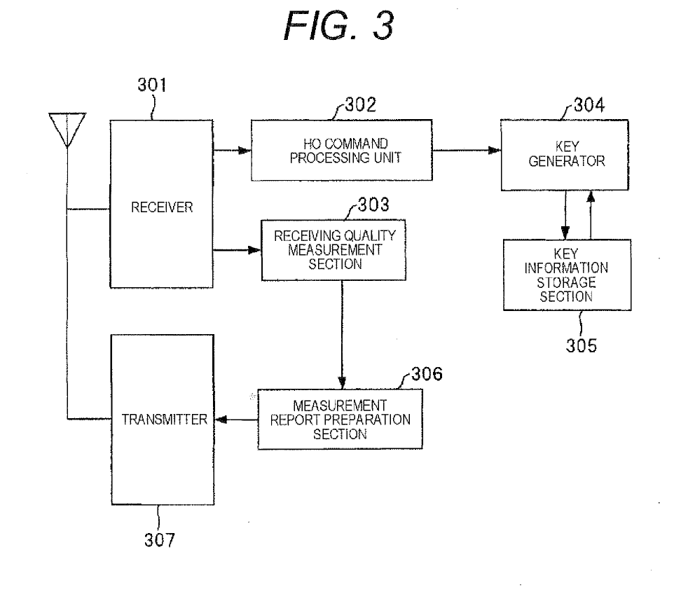

The configuration of the user equipment according to the first embodiment of the present invention is described by reference to a block diagram shown in FIG. 3.

A receiver 301 has a reception RF section, a baseband signal processing unit, and the like, and performs processing of demodulation, decoding, and like processing, of a signal received by an antenna. The receiver 301 receives an HO command and a pilot signal included in a transmission signal, both of which are sent from another base station. The HO command is output to an HO command processing unit 302, and the pilot signal is transmitted to a receiving quality measurement section 303.

The HO command processing unit 302 commands a key generator 304 to generate a key in accordance with the HO command input by the receiver 301.

The key generator 304 acquires required information from a key information storage section 305 in accordance with the command input by the HO command processing unit 302; generates an encryption key; and outputs the thus-generated encryption key to the key information storage section 305.

The key information storage section 305 stores key information input by the key generator 304. The key information storage section further outputs necessary key information to the key generator 304.

The receiving quality measurement section 303 measures receiving quality of the pilot signal input by the receiver 301 and outputs a measurement result to a measurement report preparation section 306. RSRP (Reference Signal Receiving Power), RSRQ (Reference Signal Receiving Quality), or the like, is used as the receiving quality.

The measurement report preparation section 306 prepares a measurement report (MR) from the measurement result input by the receiving quality measurement section 303 and outputs the thus-prepared report to a transmitter 307.

The transmitter 307 includes a baseband signal processing unit, a transmission RF block, and the like, and performs processing of encoding, modulation, and like processing, of a transmission signal. The transmitter 307 transmits the measurement report input by the measurement report preparation section 306 from the antenna.

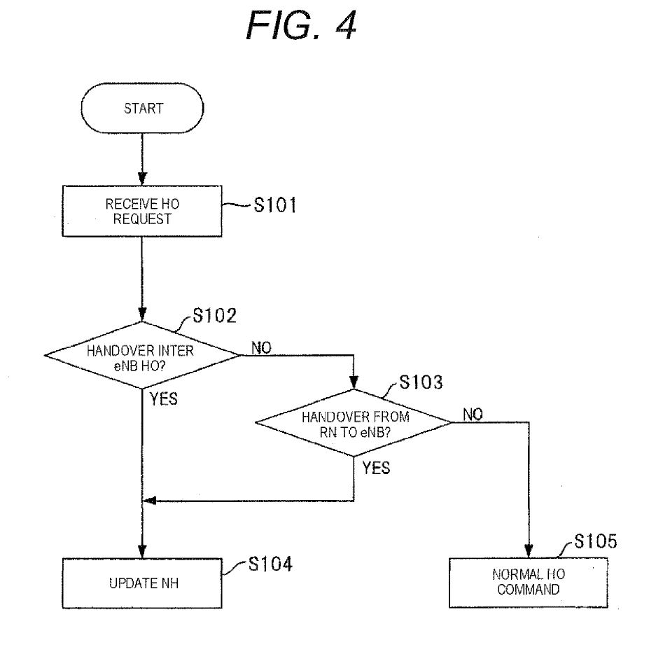

Operation of the base station according to the first embodiment of the present invention is now described by reference to the flowchart shown in FIG. 4.

The base station 101 receives an HO request from a subordinate relay node or another base station by way of the receiver 201 and the HO request processing unit 202 (S101).

Next, the user equipment information determination section 204 determines whether or not the HO request is concerned with handover from one base station to another base station (inter eNB HO) (S102). When the HO request is concerned with handover performed within the same base station, an additional determination is made as to whether or not the HO request is concerned with handover from a relay node to a base station (RN→eNB) (S103). When the base station 101 has received the HO request, the user equipment information determination section 204 can determine a type of a base station transmitted the HO request or a type of a user equipment in communication with the relay node according to the user equipment information extracted from the HO request. In this case, when the user equipment is a legacy user equipment that is not expected to utilize a relay node, processing is performed.

When the HO request corresponds to handover from one base station to another base station or when the HO request corresponds to handover from a relay node to a base station within a communication area covered by the same base station, the base station prepares a key information update request for requesting updating of key information NH by means of the key information update request preparation section 206 (S104). The transmitter 208 transmits the key information update request to a high-level management node. An HO command including information about updating of the key information is transmitted to a source base station that is an origination of the HO request or a source relay node.

When the HO request corresponds to other modes of handover; namely, handover from a base station to a relay node within a communication area covered by the same base station or handover from one relay node to another relay node within a communication area covered by the same base station, the base station prepares a normal HO command by means of the HO command preparation section 207 (S105). The transmitter 208 transmits an HO command to the user equipment by way of the source base station that is the origination of the HO request or the source relay node.

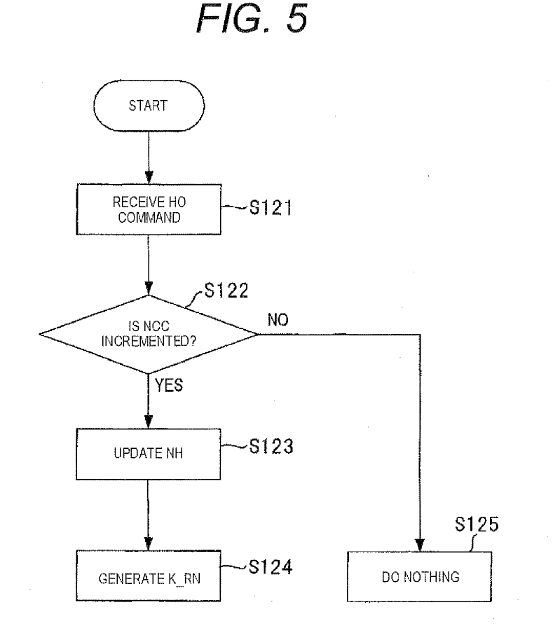

Operation of the user equipment according to the first embodiment of the present invention is described by reference to a flowchart of FIG. 5.

The user equipment 102 receives an HO command from a base station or a relay node in a currently communicable serving cell, by means of the receiver 301 and the HO command processing unit 302 (S121).

The HO command processing unit 302 then determines whether or not the NCC is incremented by reference to the NCC included in the HO command (S122). When the NCC is incremented, the user equipment updates the key information NH by means of the key generator 304, thereby generating new key information NH* (S123). On the contrary, when the NCC is not incremented, processing ends without performance of operation (S125). Subsequently, the key generator 304 generates a new key K_eNB* (K_RN*) from a held common key K_ASME, the new key information NH*, and the physical cell ID of a target base station or a target relay node that is a handover destination (S124).

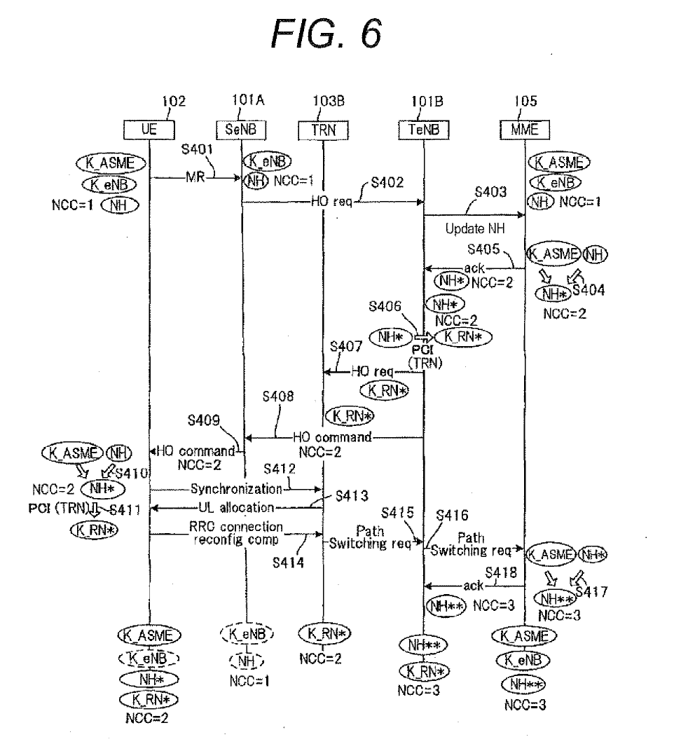

First example signaling performed between the base station and the user equipment according to the first embodiment of the present invention is now described by reference to a signaling diagram of FIG. 6.

In the example shown in FIG. 6, a base station in a base station flow chart shown in FIG. 4 corresponds to operation for generating a key information update request and transmitting the thus-generated request to the MME that is a high level management node (S104).

In FIG. 6, the user equipment is assumed to perform handover from the base station that is now in communication to a relay node subordinate to a different base station. The user equipment (UE) 102 now holds a connection with a base station (the source base station: SeNB) 101A in a currently communicable serving cell and is using the key K_eNB for communication encryption.

The user equipment 102 sends a measurement report (MR), which includes receiving quality of the pilot signal from the relay node that is to serve as a handover destination (the target relay node: TRN) 103B, to the base station (the source base station) 101A for the serving cell (S401). In this case, the user equipment 102 has already acquired the physical cell ID (PCI), as well as having measured receiving quality of the target relay node 103B.

The source base station 101A determines the received measurement report and determines the target relay node as target handover (destination) and subsequently transmits the HO request (HO req) to a base station serving as a master of the target relay node(a target base station: TeNB) 101B (S402).

Upon receipt of the HO request from the source base station 101A, the target base station 101B determines that the HO request is from a legacy user equipment and responsive to handover from a different base station to a relay node subordinate to itself. In this case, the target base station 101B prepares a key information update request for updating the key information HN and transmits the thus-prepared request to the MME 105 that is a high-level node (S403).

Upon receipt of the key information update request from the target base station 101B, the MME 105 updates the key information to new key information NH* (NCC=2) by means of the key K_ASME and the key information NH (S404) and transmits the new key information NH* while holding the information in an ACK response (ack) to the target base station 101B (S405).

Upon receipt of the new key information NH* from the MME 105, the target base station 101B prepares the key K_RN* from the key information NH* and the physical cell ID (PCI) of the target relay node 103B (S406). The HO request including the key K_RN* is transmitted to the target relay node 103B that is to serve as a handover destination (S407).

The target base station 101B prepares an HO command including the new NCC information (NCC=2) and transmits the command to the user equipment 102 by way of the source base station 101A (S408, S409).

Upon receipt of the HO command transmitted from the target base station 101B by way of the source base station 101A, the user equipment 102 makes a reference to the NCC included in the HO command. In this case, since the NCC is incremented as a result of the key information NH being updated by the MME 105, the user equipment 102 also updates the key information NH such that the NCC of the user equipment 102 and the NCC of the MME 105 are matched. Specifically, the user equipment 102 updates the key information to the new key information NH* (NCC=2) from the key K_ASME and the key information NH (S401). Subsequently, the user equipment 102 generates the key K_RN* from the key K_ASME, the new key information NH* generated from the current key information NH, and the physical cell ID (PCI) of the target relay node 103B (S411).

Subsequently, the user equipment 102 transmits the RACH message (Synchronization) for accomplishing synchronization to the target relay node 103B (S412) and is allocated an uplink resource (UL allocation) by the target relay node 103B (S413). An RRC connection reconfiguration complete (RRC connection reconfig comp) is transmitted from the user equipment 102 to the target relay node 103B (S414), and a path switching request (Path Switching req) is transmitted from the target relay node 103B to the MME 105 that is a high-level management node by way of the target base station 101B (S415 and S416). The MME 105 updates the key information to new key information NH** (NCC=3) from the key K_ASME and the key information NH* (S417) and transmits the key information NH** to the target base station 101B while holding the key information in the ACK response (ack) (S418). Handover from one base station to a relay node subordinate to another base station is performed through a round of the previously described processing operations.

Subsequent to execution of handover, the key K_RN* is used for encrypting communication between the user equipment 102 and the target relay node 103B and the target base station 101B.

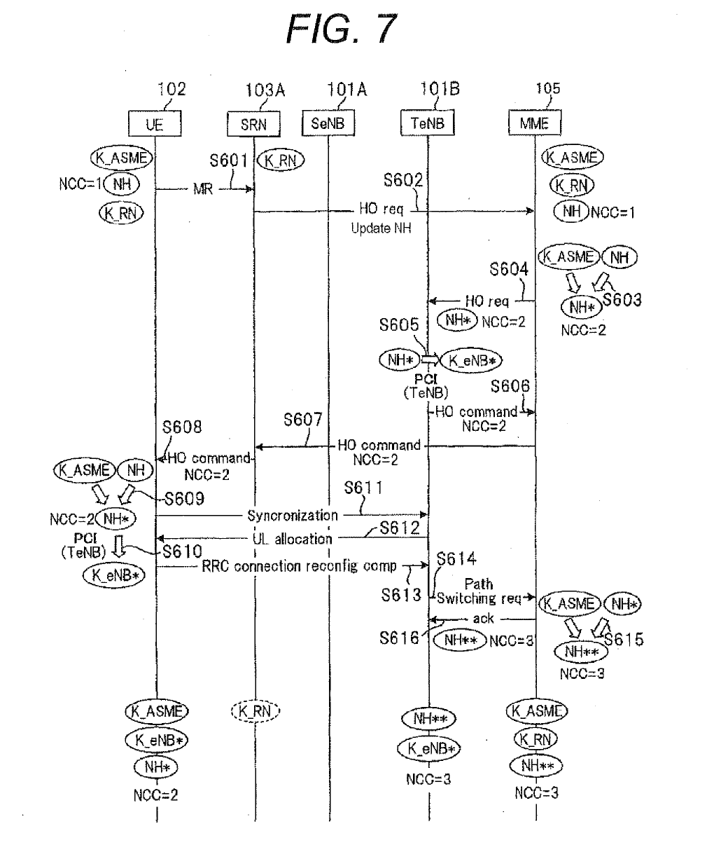

Second example signaling performed between the base station and the user equipment according to the first embodiment of the present invention is now described by reference to a signaling diagram of FIG. 7.

The example shown in FIG. 7 corresponds to operation by means of which the relay node determines the measurement report from the user equipment, to thus generate the key information update request, and transmits the request directly to the MME that is a high-level management node while bypassing the base station.

In FIG. 7, the user equipment executes handover from the relay node now in communication to a base station differing from its high-level base station. The user equipment (UE) 102 holds a connection with the relay node (a source relay node: SRN) 103A of a currently communicable serving cell and uses the key K_RN for communication encryption.

The user equipment 102 transmits, to the relay node (the source relay node) 103A in the serving cell, the measurement report (MR) including receiving quality of the pilot signal of the base station (a target base station: TeNB) 101B that is to act as a handover destination (S601). In this case, the user equipment 102 has already acquired the physical cell ID (PCI), as well as having already measured received quality of the target base station 101B.

The source relay node 103A determines, from the received measurement report, that the HO request is sent by the legacy user equipment and responsive to handover to a base station differing from the high-level base station. In this case, the source relay node 103A prepares an HO request (HO req) including the key information update request for updating the key information HN and transmits the request to the MME 105 (S602).

Upon receipt of the key information update request from the source relay node 103A, the MME 105 updates the key information to the new key information NH* (NCC=2) from the key K_ASME and the key information NH (S603) and transmits the new key information NH* while holding the information in the HO request (HO req) to the target base station 101B (S604).

Upon receipt of the new key information NH* from the MME 105, the target base station 101E prepares the key K_eNB* from the key information NH* and its own physical cell ID (PCI) (S605).

The target base station 101B prepares the HO command including new NCC information (NCC=2) and transmits the HO command to the user equipment 102 by way of the MME 105 and the source relay node 103A (S606, S607, and S608).

Upon receipt of the HO command transmitted from the target base station 101B by way of the source relay node 103A, the user equipment 102 makes a reference to the NCC included in the HO command. In this case, the NCC has already been incremented as a result of the MME 105 having updated the key information NH. Hence, the user equipment 102 also updates the key information HN such that the NCC of the user equipment 102 and the NCC of the MME 105 are matched. Specifically, the user equipment 102 updates the key information to the new key information NH* (NCC=2) from the key K_ASME and the key information NH (S609). Subsequently, the user equipment 102 generates the key K_eNB* from the key K_ASME, the new key information NH* generated from the current key information NH, the physical cell ID (PCI) of the target base station 101E (S610).

Subsequently, an RACH message (Synchronization) for accomplishing synchronization is transmitted from the user equipment 102 to the target base station 101B (S611) and the user equipment 102 is allocated an uplink resource (UL allocation) by the target base station 101B (S612). The user equipment 102 transmits the RRC connection reconfiguration complete (RRC connection reconfig comp) to the target base station 101B (S613), and the target base station 101B transmits a path switching request (Path Switching req) to the MME 105 that is a high level management node (S614). The MME 105 updates the key information to the new key information NH** (NCC=3) from the key K_ASME and the key information NH* (S615) and transmits the key information NH** while holding the information in an ACK response (ack) to the target base station 101B (S616). Handover from one relay node to a base station differing from the high level base station for the relay node is executed through a round of above-described processing operations.

Subsequent to execution of handover, the key K_eNB* is used for encrypting communication between the user equipment 102 and the target base station 101B.

As mentioned above, in the present embodiment, in the case of handover from a relay node of one base station or from the base station to a relay node of another base station or to the other base station or in the case of handover from a relay node of one base station to a high level base station for the relay node, a key information update request from the base station to the high level management node is prepared and notified, whereby key information for generating a key can be updated. There are also cases where the relay node rather than the base station prepares the key information update request and transmits the thus-prepared request directly to the high-level management node while bypassing the base station. In these cases, the legacy user equipment which is not expected to utilize a relay node can prevent occurrence of a mismatch among the user equipment, the base station, and the relay node in terms of the NCC of the key information NH, so that the key information can be appropriately updated. Consequently, when the relay nodes are being introduced into the wireless communication system, the legacy user equipment can correctly generate and use a common key between the user equipment and the base station and between the user equipment and the relay node.

The present invention is also scheduled to be subjected to various alterations and applications conceived by the persons skilled in the art according to the descriptions of the present patent specification and the well known techniques, without departing the spirit and scope of the present invention, and the alterations and applications shall also fall within a scope where protection of the present invention is sought. Further, the constituent elements described in connection with the embodiment can also be arbitrarily combined together without departing the purport of the present invention.

Although the present embodiment has provided explanations by means of taking, as examples, a case where the present invention is configured by means of hardware, the present invention can also be implemented by software.

The respective function blocks used for describing the embodiment are typically implemented by LSIs that are integrated circuits. The function blocks can also be individually realized as single chips or as a single chip including some or all of the function blocks. Although the functional blocks are embodied as LSIs, they are sometimes called an IC, a system LSI, a super LSI, and an ultra-LSI according to a degree of integration.

The technique for integrating the function blocks into circuitry is not limited to LSI technology, and the function blocks can also be implemented by means of a custom-designed circuit or a general-purpose processor. Further, an FPGA (Field Programmable Gate Array) capable of being programmed after manufacture of an LSI and a reconfigurable processor whose connections or settings of circuit cells in an LSI can be reconfigured can also be utilized.

Further, if a technique for integrating circuits replaceable with the LSI technology by virtue of advancement of the semiconductor technology or another technique derived from advancement of the semiconductor technology has emerged, the function blocks can naturally be integrated by use of the technique. Adaptation of biotechnology is feasible.

The present patent application is based on Japanese Patent Application (No. 2009-101294) filed on Apr. 17, 2009, the entire subject matter of which is incorporated herein by reference.

### INDUSTRIAL APPLICABILITY

The present invention yields an advantage of the ability to enable a legacy terminal to correctly generate and use a common key between a user equipment and a base station and between the user equipment and a relay node when relay nodes are being introduced into a cellular mobile communication system. Thus, the invention is useful as a wireless communication apparatus applicable to a wireless communication base station apparatus, a wireless communication user equipment, and the like.

### REFERENCE SIGNS LIST

101, 101A, 101B: BASE STATION

102: USER EQUIPMENT

103, 103A, 103B, 103C: RELAY NODE

105: MME

201: RECEIVER

202: HO REQUEST PROCESSING UNIT

203: KEY INFORMATION STORAGE SECTION

204: USER EQUIPMENT INFORMATION DETERMINATION SECTION

205: KEY GENERATOR

206: KEY INFORMATION UPDATE REQUEST GENERATOR

207: HO COMMAND PREPARATION SECTION

208: TRANSMITTER

301: RECEIVER

302: HO COMMAND PROCESSING UNIT

303: RECEIVING QUALITY MEASUREMENT SECTION

304: KEY GENERATOR

305: KEY INFORMATION STORAGE SECTION

306: MEASUREMENT REPORT PREPARATION SECTION

307: TRANSMITTER

1-5. (canceled)

6. A wireless communication apparatus, comprising:
a receiver that receives a handover request representing a request for handover, which is sent from another apparatus, and receives key information about an encryption key;
a handover request processing unit that processes the handover request received by the receiver;
a key information storage section that stores the key information received by the receiver;
a user equipment information determination section that determines a mode of handover in accordance with user equipment information extracted by the handover request processing unit;
a key generator that generates a key from the key information stored in the key information storage section in accordance with a determination result of the user equipment information determination section;
a key information update request preparation section that prepares a key information update request for requesting updating of key information in accordance with a determination result of the user equipment information determination section;
a handover command preparation section that prepares a handover command for commanding execution of handover in accordance with a determination result of the user equipment information determination section; and
a transmitter that transmits the key information update request prepared by the key information update request preparation section and the handover command prepared by the handover command preparation section.

7. The wireless communication apparatus according to claim 6, wherein
either when a user equipment that is in communication with the apparatus which has transmitted the handover request performs handover from a relay node to a high-level base station to which the relay node is subordinate or when the user equipment performs handover from a base station or a relay node subordinate to the base station to another base station or a relay node subordinate to the other base station, the user equipment information determination section commands the key information update request preparation section to prepare a key information update request to a high-level management node.

8. The wireless communication apparatus according to claim 7, wherein
when the user equipment is a legacy user equipment which is not expected to utilize a relay node, the user equipment information determination section commands the key information update request preparation section to prepare the key information update request.

9. A base station apparatus comprising the wireless communication apparatus as defined in claim 6.

10. A wireless communication system comprising the base station apparatus as defined in claim 9.
